(19) United States
(12) Patent Application Publication
(10) Pub. No.: US 2022/0358564 A1
(43) Pub. Date: Nov. 10, 2022

(54) Detection of Anomalous Quantities in Data Records Using Predicted Quantities of Similar Entities

(71) Applicant: EMC IP Holding Company LLC, Hopkinton, MA (US)

(72) Inventors: Noga Gershon, Beer Sheva (IL); Amihai Savir, Sansana (IL); Dhev Kollannur, Austin, TX (US); Ivan Mlynek, D. Jurkovica (SK)

(21) Appl. No.: 17/308,531

(22) Filed: May 5, 2021

(51) Int. Cl. G06Q 30/06; G06F 16/28; G06F 16/2455; G06F 16/23; G06K 9/62

(52) U.S. Cl. CPC G06Q 30/0633; G06F 16/285; G06F 16/24556; G06F 16/24558; G06F 16/2358; G06F 16/2365; G06K 9/6215

(57) ABSTRACT

Techniques are provided for detecting anomalous quantities in data records using predicted quantities of similar entities. One method comprises obtaining data records corresponding to item groupings and comprising entity feature values and quantity feature values; in response to a new data record associated with a given entity: generating an expected quantity of an item by evaluating a pairwise similarity score based on a pairwise entity similarity value and a pairwise quantity similarity value; identifying an additional entity having a pairwise similarity score with the given entity that satisfies an entity similarity criteria; and determining the expected quantity of the item using: (i) the pairwise similarity score between the given entity and the identified additional entity and (ii) the quantity of the item associated with the identified additional entity; comparing the expected quantity to a quantity indicated in the new data record; and performing an automated remedial action based on a result of the comparing.

### FIELD

The field relates generally to information processing systems, and more particularly to the processing of data records in such systems.

### SUMMARY

In one embodiment, a method comprises obtaining a plurality of data records, wherein each data record corresponds to a different item grouping of one or more items and comprises a plurality of feature values related to a corresponding item grouping, wherein the plurality of feature values comprises a first feature group comprising one or more first feature values related to an entity associated with the corresponding item grouping and a second feature group comprising one or more second feature values related to one or more quantities associated with the corresponding item grouping, and wherein the entity associated with the corresponding item grouping is one of a plurality of entities associated with the plurality of data records; in response to obtaining a new data record corresponding to a given item grouping of one or more items and being associated with a given entity: generating a prediction of an expected quantity of at least one of the one or more items of the given item grouping associated with the new data record, wherein the expected quantity of the at least one item of the given item grouping is obtained by: evaluating a pairwise similarity score between the given entity and each of at least one entity of the plurality of entities based at least in part on a pairwise entity similarity value, between the given entity and the at least one entity, using the one or more first feature values and a pairwise quantity similarity value, between the given entity and the at least one entity, using the one or more second feature values; identifying one or more entities of the plurality of entities having a pairwise similarity score with the given entity that satisfies one or more entity similarity criteria; and determining the expected quantity of the at least one item of the given item grouping using an aggregation of: (i) the pairwise similarity score between the given entity and each of the identified one or more entities of the plurality of entities and (ii) the corresponding quantity of the at least one item of the given item grouping associated with each of the identified one or more entities of the plurality of entities; comparing the expected quantity of the at least one item of the given item grouping to a quantity of the at least one item indicated in the new data record; and performing one or more automated remedial actions in response to a result of the comparing.

In some embodiments, the one or more second feature values related to the one or more quantities associated with the corresponding item grouping comprise a quantity value for each of a plurality of item classes in the corresponding item grouping. The comparing may comprise evaluating a difference between the expected quantity of the at least one item of the given item grouping and the quantity of the at least one item indicated in the new data record and aggregating the difference for each of the one or more items in the given item grouping.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for detection of anomalous quantities in data records using predicted quantities of similar entities in accordance with an illustrative embodiment;

FIG. 2 is a flow diagram illustrating an exemplary implementation of a process for anomalous quantity detection, according to some embodiments of the disclosure;

FIG. 3 is a flow diagram illustrating an exemplary implementation of a process for detecting anomalous quantities in data records using predicted quantities of similar entities, according to some embodiments of the disclosure;

FIG. 4 illustrates an exemplary processing platform that may be used to implement at least a portion of one or more embodiments of the disclosure comprising a cloud infrastructure; and

FIG. 5 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for detection of anomalous quantities in data records using predicted quantities of similar entities.

A grey market refers to distribution channels for a product or service that are not authorized by the provider and/or a trademark owner. Grey market products are thus products traded outside of an authorized channel. In some cases, a customer may obtain one or more products, for example, for sale in the grey market by misrepresenting the intent or an aspect of an otherwise legitimate transaction. For example, a customer may receive a discounted price for one or more products purchased from a manufacturer or wholesaler (e.g., by falsifying or concealing the identity of the ultimate end user(s)) with an intent to sell the purchased products to a third party in the grey market at a higher price. Among other benefits, identifying such transactions can prevent margin leakage for the manufacturer or wholesaler and other negative impacts (e.g., customers being confused by aggressive pricing from third parties, customers or partners being exposed to pricing given to other purchasers, and circumventing established controls for pricing).

A manufacturer or wholesaler may vary pricing for products or services based on, for example, a customer identity, a size of the deal and/or a type of the end user that consumes the products or services. As noted above, a customer or partner may misrepresent the intent of a transaction with the goal of obtaining a favorable discount from the manufacturer or wholesaler and then selling the obtained products or services to a third party at a higher price to make a profit.

In one or more embodiments, the disclosed techniques for detection of anomalous quantities in data records using predicted quantities of similar entities employ collaborative filtering and statistical techniques. Generally, collaborative filtering is a technique used, for example, by recommender systems. Collaborative filtering can be used to generate predictions for a certain user by collecting taste information or preferences from multiple users. Collaborative filtering assumes that if user A has an opinion that is similar to an opinion of user B regarding a certain matter, users A and B will have a similar opinion on a different matter in comparison to other randomly chosen users.

In some embodiments, the disclosed techniques for anomalous order quantity detection utilize the fact that account A purchased similar products to account B to predict the purchase quantity of an item for account B. The predicted quantity provides a good indication as to whether a certain quote was falsified or was actually submitted by the account. If an anomalous order quantity is detected, the associated order can be flagged for further examination. In addition, following further examination, a decision can be made as to whether the quote should be denied, or whether the price should be raised in such a way that it will not compete with the prices of the manufacturer or wholesaler.

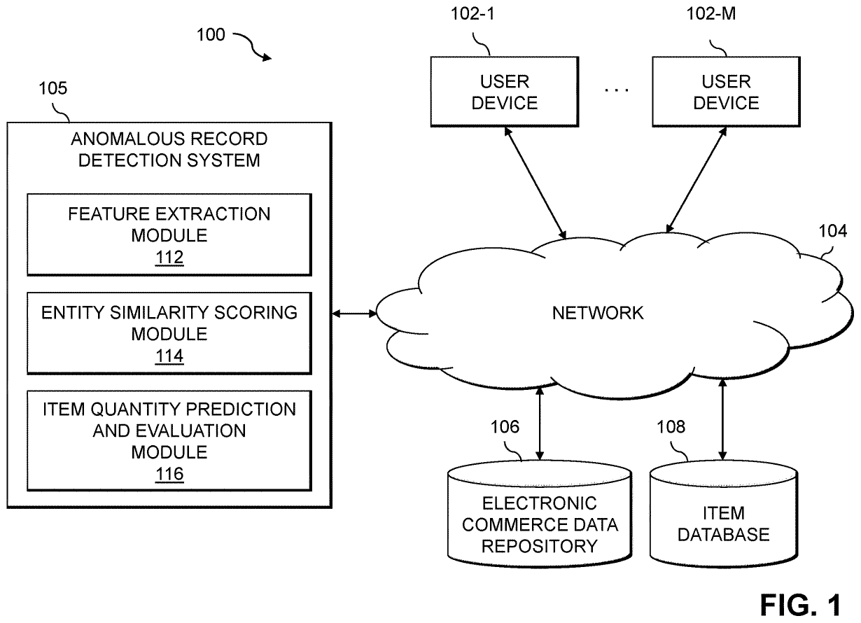

FIG. 1 shows a computer network (also referred to herein as an information processing system) 100 configured in accordance with an illustrative embodiment. The computer network 100 comprises a plurality of user devices 102-1 through 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is an anomalous record detection system 105, an electronic commerce data repository 106 and an item database 108, each discussed below.

The user devices 102 may comprise, for example, host devices and/or devices such as mobile telephones, laptop computers, tablet computers, desktop computers, appliances, electronics products, or other types of computing devices. Such devices are examples of what are more generally referred to herein as “processing devices.” Some of these processing devices are also generally referred to herein as “computers.”

The user devices 102 may comprise a network client that includes networking capabilities such as ethernet, Wi-Fi, etc. When the user devices 102 are implemented as host devices, the host devices may illustratively comprise servers or other types of computers of an enterprise computer system, cloud-based computer system or other arrangement of multiple compute nodes associated with respective users.

For example, the host devices in some embodiments illustratively provide compute services such as execution of one or more applications on behalf of each of one or more users associated with respective ones of the host devices. Such applications illustratively generate input-output (IO) operations that are processed by a storage system. The term “input-output” as used herein refers to at least one of input and output. For example, IO operations may comprise write requests and/or read requests directed to logical addresses of a particular logical storage volume of the storage system. These and other types of IO operations are also generally referred to herein as IO requests.

The user devices 102 in some embodiments comprise respective processing devices associated with a particular company, organization or other enterprise or group of users. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The anomalous record detection system 105 may be implemented, for example, on the cloud or on the premises of an enterprise or another entity. In some embodiments, the anomalous record detection system 105, or portions thereof, may be implemented as part of a storage system or on a host device.

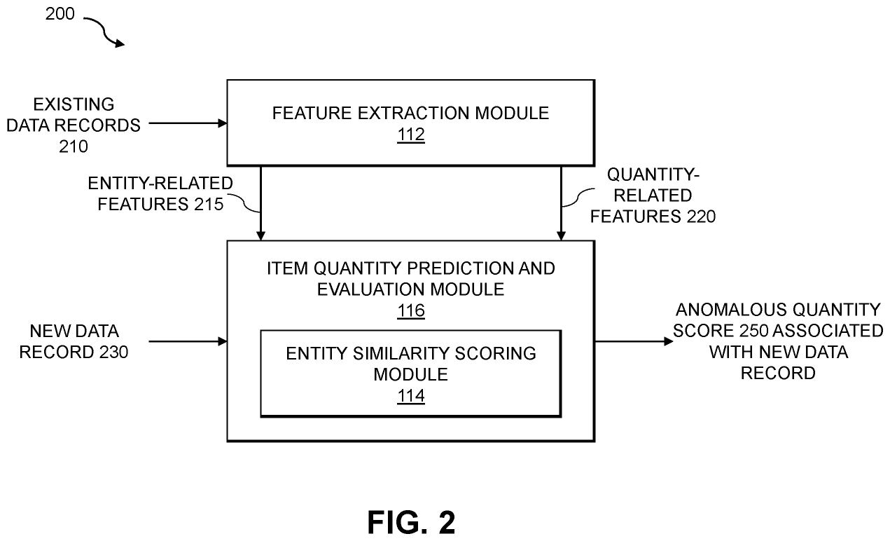

As also depicted in FIG. 1, the anomalous record detection system 105 further comprises a feature extraction module 112, an entity similarity scoring module 114 and an item quantity prediction and evaluation module 116, each discussed further below. In at least some embodiments, the feature extraction module 112 extracts feature values from data records and/or electronic commerce websites (e.g., using crawling techniques) for processing by the disclosed techniques for anomalous order quantity detection. For example, electronic commerce websites or other external sources may provide a buying power, number of employees and/or revenue information for various entities, as discussed further below in conjunction with FIG. 2.

In at least some embodiments, the entity similarity scoring module 114 evaluates a similarity between different entities (e.g., purchasing entities), as discussed further below in conjunction with FIG. 2. The item quantity prediction and evaluation module 116 employs prediction techniques to predict an expected quantity for an order and to evaluate whether the determined expected value is anomalous.

It is to be appreciated that this particular arrangement of modules 112, 114 and 116 illustrated in the anomalous record detection system 105 of the FIG. 1 embodiment is presented by way of example only, and alternative arrangements can be used in other embodiments. For example, the functionality associated with one or more of the modules 112, 114 and 116 in other embodiments can be implemented as a single module or device, or separated across a larger number of modules. As another example, multiple distinct processors can be used to implement different ones of modules 112, 114 and 116, or portions thereof.

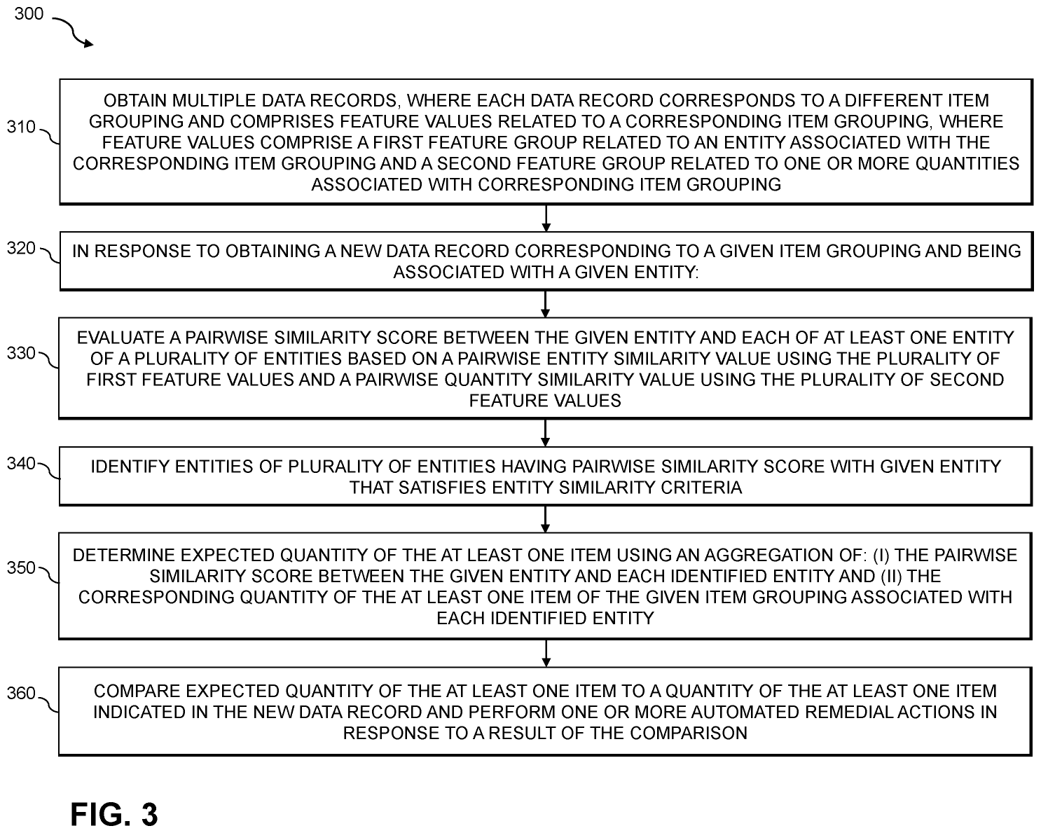

At least portions of modules 112, 114 and 116 may be implemented at least in part in the form of software that is stored in memory and executed by a processor. An exemplary process utilizing one or more of modules 112, 114 and 116 for an example anomalous record detection system 105 in computer network 100 will be described in more detail with reference to, for example, FIGS. 2 and 3.

Additionally, the anomalous record detection system 105 can have an associated electronic commerce data repository 106 configured to store, for example, data for a number of electronic commerce websites. In some embodiments, the electronic commerce data repository 106 may comprise the electronic commerce websites from which data is extracted (e.g., by the feature extraction module 112 using crawling techniques) for processing by the disclosed techniques for anomalous order quantity detection.

In addition, the anomalous record detection system 105 can have an associated item database 108 configured to store, for example, various data records associated with various products, for example, or other items, such as product type, product name, product price, product configuration and product family. In at least some embodiments, the exemplary data records comprise a plurality of features extracted from a data source, such as from the electronic commerce data repository 106.

In one or more embodiments, the item database 108 is generated, at least in part, using crawling techniques on selected eCommerce websites to extract information about purchasers and/or products of relevant brands and their relationship. For example, product information may be extracted for each product, such as: product quantity, product type, product price, product title or name, product family and product configuration.

One or more of the electronic commerce data repository 106 and item database 108 in the present embodiment are implemented using one or more storage systems associated with the anomalous record detection system 105. Such storage systems can comprise any of a variety of different types of storage including such as network-attached storage (NAS), storage area networks (SANs), direct-attached storage (DAS) and distributed DAS, as well as combinations of these and other storage types, including software-defined storage.

At least some of the user devices 102 and the anomalous record detection system 105 may be implemented on a common processing platform, or on separate processing platforms. The user devices 102 (for example, when implemented as host devices) are illustratively configured to write data to and read data to/from the storage system in accordance with applications executing on those host devices for system users.

The computer network 100 may also comprise one or more storage devices, such as the storage systems used to implement one or more of the electronic commerce data repository 106 and item database 108. The storage devices illustratively comprise solid state drives (SSDs). Such SSDs are implemented using non-volatile memory (NVM) devices such as flash memory. Other types of NVM devices that can be used to implement at least a portion of the storage devices include non-volatile RAM (NVRAM), phase-change RAM (PC-RAM), magnetic RAM (MRAM), resistive RAM, spin torque transfer magneto-resistive RAM (STT-MRAM), and Intel Optane™ devices based on 3D XPoint™ memory. These and various combinations of multiple different types of NVM devices may also be used. For example, hard disk drives (HDDs) can be used in combination with or in place of SSDs or other types of NVM devices in the storage system.

It is therefore to be appreciated that numerous different types of storage devices can be investigated in other embodiments. For example, a given storage system can include a combination of different types of protected storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices.

The term “storage system” as used herein is therefore intended to be broadly construed, and should not be viewed as being limited to particular storage system types, such as, for example, CAS (content-addressable storage) systems, distributed storage systems, or storage systems based on flash memory or other types of NVM storage devices. A given storage system as the term is broadly used herein can comprise, for example, any type of system comprising multiple storage devices, such as NAS, SANs, DAS and distributed DAS, as well as combinations of these and other storage types, including software-defined storage.

The user devices 102 are configured to interact over the network 104 with the anomalous record detection system 105, and/or other devices.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the user devices 102 and the storage system to reside in different data centers. Numerous other distributed implementations of the host devices and the storage system are possible.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the anomalous record detection system 105 can be one or more input-output devices (not shown), which illustratively comprise keyboards, displays or other types of input-output devices in any combination. Such input-output devices can be used, for example, to support one or more user interfaces to the anomalous record detection system 105, as well as to support communication between the anomalous record detection system 105 and other related systems and devices not explicitly shown.

The user devices 102 and the anomalous record detection system 105 in the FIG. 1 embodiment are assumed to be implemented using at least one processing device. Each such processing device generally comprises at least one processor and an associated memory, and implements one or more functional modules for controlling certain features of the anomalous record detection system 105.

More particularly, user devices 102 and anomalous record detection system 105 in this embodiment each can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including SSDs, and should therefore not be viewed as limited in any way to spinning magnetic media.

A network interface allows the user devices 102 and/or the anomalous record detection system 105 to communicate over the network 104 with each other (as well as one or more other networked devices), and illustratively comprises one or more conventional transceivers.

It is to be understood that the particular set of elements shown in FIG. 1 for anomalous order quantity detection is presented by way of illustrative example only, and in other embodiments additional or alternative elements may be used. Thus, another embodiment includes additional or alternative systems, devices and other network entities, as well as different arrangements of modules and other components.

FIG. 2 illustrates an exemplary process 200 for anomalous order quantity detection, according to some embodiments of the disclosure. In the example of FIG. 2, existing data records 210 are obtained, each corresponding to different item groupings of one or more items (e.g., different product orders for one or more items). For example, the existing data records 210 may comprise the most recent order information from the past 24 hours that are processed to evaluate engineered features that are used to predict an expected quantity for a new order.

The feature extraction module 112 of FIG. 1 extracts a plurality of entity-related features 215 and a plurality of quantity-related features 220. The entity-related features 215 are related to an entity associated with each data record 210 and the feature values may be obtained from an external source, such as the electronic commerce data repository 106, as discussed below. The quantity-related features 220 are related to one or more quantities associated with each data record.

As shown in FIG. 2, the entity-related features 215 and the quantity-related features 220 are processed by the item quantity prediction and evaluation module 116 of FIG. 1, for example, in response to receipt of a new data record 230. The item quantity prediction and evaluation module 116 employs the entity similarity scoring module 114 of FIG. 1 to evaluate a similarity between different entities (e.g., purchasing entities), as discussed further below in conjunction with FIG. 3.

In some embodiments, the item quantity prediction and evaluation module 116 calculates the expected quantity of each product in a given quote or order. For example, the item quantity prediction and evaluation module 116 can process the entity-related features 215, such as a buying power of each entity or purchaser, a number of employees in the entity and various revenue information, such as quarterly revenue for various product types or classes (e.g., end user devices, such as laptop and desktop computers, versus servers).

In addition, the quantity-related features 220 may comprise, in at least some embodiments, quarterly purchase quantity data, for each account or entity, and/or for each line-of-business, the number of purchased display monitors, client peripherals, notebook devices and desktop computers, for example.

In some embodiments, the following rule may be employed to capture products that are frequently bought for each account, using, for example, a binary matrix where every cell value will be calculated as follows:

$${y}_{a , p} = \{ \begin{matrix}1 & if {x}_{a , p} \geq 50 \\ 0 & otherwise\end{matrix} .$$

The above rule allows a similarity to be determined between purchased products regardless of the purchased quantity (e.g., the above rule excludes ordered items with low quantities).

When a new order quote is generated, the extracted entity-related features 215 and quantity-related features 220 are used to identify accounts that are similar to the account in question (e.g., the account or entity associated with the new order quote).

A similarity score between the accounts can be calculated for each group of features (e.g., entity-related features 215 and quantity-related features 220) separately, as follows:

similarity score=A_{w}·Aₛ+PP_{w}·PPₛ,

where:

A_{w}—weight given to entity—related features 215 (e.g., A_{w}=0.3);

Aₛ—pairwise entity similarity score using entity—related features 215;

PP_{w}—weight given to quantity—related features 220 (e.g., PP_{w}=0.7); and

PPₛ—pairwise quantity similarity score using quantity—related features 220.

In order to predict the expected quantity, in at least some embodiments, accounts with similar purchase patterns are considered (e.g., otherwise the calculation may not be feasible). The similarity calculation of the feature groups can be done using cosine or Pearson correlation.

After the above similarities are calculated, the accounts with a score above a threshold (e.g., 0.8) can be extracted before moving to the next step. The base expected quantity is calculated for each product in the order based on the similarity measure, using the historical purchase patterns. The expected quantity for the account in question (e.g., the account associated with the new order) can be calculated, as follows:

$${expected\_qty}_{k} = \frac{{\sum }_{j = 1}^{n} s c o r {e}_{j} * {qty}_{j , k}}{{\sum }_{j = 1}^{n} s c o r {e}_{j}} ,$$

where:

scoreⱼ—aggregated similarity score for account in question and account j;

qty_{j,k}—quantity purchased from product k; and

k—product being estimated.

The above expected quantity equation provides an estimate for the expected quantity of a certain product, k. However, in some cases where the size of two companies is significantly different, a biased estimate may be obtained. In some embodiments, a normalization method can reduce this bias and provide a better estimate. In a first normalization method, using all products, the normalization factor, factorⱼ, for each account is calculated as follows:

$${factor}_{j} = \frac{{\sum }_{k = 1}^{m} \frac{{qty}_{j , k}}{{qty}_{i , k}}}{m} ,$$

where:

factorⱼ—normalization factor for account j;

k—products purchased by both accounts; and

m—number of different products common to both accounts.

In a second normalization method, the pre-calculated similarity between products is used to find the most similar product for every examined product. The quantities of the most similar product, for both accounts, will be used as follows:

$${factor}_{j , k} = \frac{most\_similar {\_qty}_{j , k}}{most\_similar {\_qty}_{i , k}}$$

where:

factor_{j,k}—factor for account j and product k;

most_similar_qty_{j,k}—quantity of account j for most similar product;

most_similar_qty_{i,k}—quantity of examined account i for most similar product.

The estimate of the expected quantity of a certain product, k, can then be adjusted using the computed normalization factor, as follows:

$${expected\_qty}_{k} = \frac{{Σ}_{j = 1}^{n} {score}_{j} * \frac{{qty}_{j , k}}{{factor}_{j , k}}}{{Σ}_{j = 1}^{n} {score}_{j}} .$$

An anomalous quantity score 250 can then be generated in some embodiments, to assess the computed quantity. For each product in an order, a gap is calculated from the expected quantity, as follows:

$${gap}_{k} = \frac{{actual\_qty}_{k} - {expected\_qty}_{k}}{{expected\_qty}_{k}} .$$

Thereafter, an aggregated score can be calculated in some embodiments using the products in the order, where the actual quantity specified in the new order exceeds the expected quantity (actual_qtyₖ>expected_qtyₖ). The final anomalous quantity score 250 can be calculated as follows:

$$score = {\sum }_{k = 1}^{m} {gap}_{k} * \frac{{actual\_qty}_{k}}{{\sum }_{k = 1}^{m} {actual\_qty}_{k}} .$$

FIG. 3 is a flow diagram illustrating an exemplary implementation of an anomalous order quantity detection process 300 that uses predicted quantities of similar entities, according to some embodiments of the disclosure. In step 310, the exemplary anomalous order quantity detection process 300 obtains multiple data records, wherein each data record corresponds to a different item grouping of one or more items and comprises a plurality of feature values related to a corresponding item grouping, wherein the plurality of feature values comprises a first feature group comprising one or more first feature values related to an entity associated with the corresponding item grouping and a second feature group comprising one or more second feature values related to one or more quantities associated with the corresponding item grouping, and wherein the entity associated with the corresponding item grouping is one of a plurality of entities associated with the plurality of data records.

In response to obtaining a new data record, detected in step 320, corresponding to a given item grouping of one or more items and being associated with a given entity: generating a prediction of an expected quantity of at least one of the one or more items of the given item grouping associated with the new data record, wherein the expected quantity of the at least one item of the given item grouping is obtained by: evaluating a pairwise similarity score in step 330 between the given entity and at least one entity of the plurality of entities based at least in part on a pairwise entity similarity value, between the given entity and the at least one entity, using the one or more first feature values and a pairwise quantity similarity value, between the given entity and the at least one entity, using the one or more second feature values; identifying one or more entities of the plurality of entities in step 340 having a pairwise similarity score with the given entity that satisfies one or more entity similarity criteria; and determining the expected quantity in step 350 of the at least one item of the given item grouping using an aggregation of: (i) the pairwise similarity score between the given entity and each of the identified one or more entities of the plurality of entities and (ii) the corresponding quantity of the at least one item of the given item grouping associated with each of the identified one or more entities of the plurality of entities.

In step 360, the expected quantity of the at least one item of the given item grouping is compared to a quantity of the at least one item indicated in the new data record, and one or more automated remedial actions are performed in response to a result of the comparison.

In some embodiments, the one or more second feature values related to one or more quantities associated with the corresponding item grouping comprise a plurality of binary features having a first binary value if a respective quantity exceeds a specified threshold and a second binary value if the respective quantity does not exceed the specified threshold. The first feature values related to the entity associated with the corresponding item grouping may comprise a value for one or more of a buying power of the entity associated with the corresponding item grouping, a number of employees of the entity associated with the corresponding item grouping, and a revenue of the entity associated with the corresponding item grouping for one or more item classes.

The one or more second feature values related to the one or more quantities associated with the corresponding item grouping may comprise a quantity value for each of a plurality of item classes in the corresponding item grouping.

In addition, in at least some embodiments, the comparing comprises evaluating a difference between the expected quantity of the at least one item of the given item grouping and the quantity of the at least one item indicated in the new data record and aggregating the difference for each of the one or more items in the given item grouping.

The particular processing operations and other network functionality described in conjunction with FIGS. 2 and 3, for example, are presented by way of illustrative example only, and should not be construed as limiting the scope of the disclosure in any way. Alternative embodiments can use other types of processing operations for detection of anomalous quantities in data records using predicted quantities of similar entities. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

The disclosed techniques for anomalous order quantity detection, in at least some embodiments, leverage collaborative filtering to perform an inverse operation than conventional techniques, whereby an item order is not recommended and is flagged as potentially contributing to the grey market. In addition, the disclosed techniques for anomalous order quantity detection employ normalization techniques that allow comparisons between accounts of different sizes.

One or more embodiments of the disclosure provide improved methods, apparatus and computer program products for detection of anomalous quantities in data records using predicted quantities of similar entities. The foregoing applications and associated embodiments should be considered as illustrative only, and numerous other embodiments can be configured using the techniques disclosed herein, in a wide variety of different applications.

It should also be understood that the disclosed anomalous order quantity detection techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for detection of anomalous quantities in data records using predicted quantities of similar entities may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based anomalous order quantity detection engine, or portions thereof, are illustratively implemented for use by tenants of such a multi-tenant environment.

Cloud infrastructure as disclosed herein can include cloud-based systems such as AWS, GCP and Microsoft Azure. Virtual machines provided in such systems can be used to implement at least portions of a cloud-based anomalous order quantity detection platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

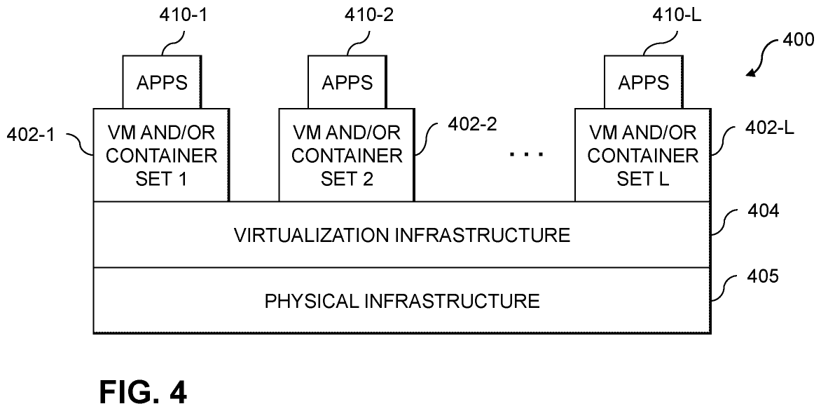

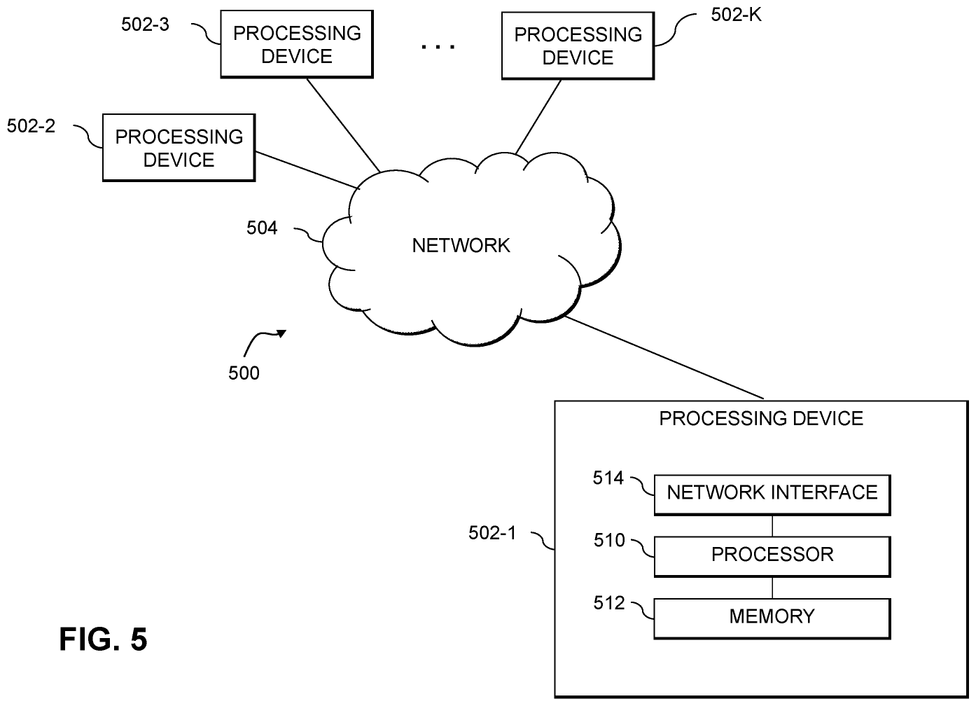

Illustrative embodiments of processing platforms will now be described in greater detail with reference to FIGS. 4 and 5. These platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. Such implementations can provide anomalous order quantity detection functionality of the type described above for one or more processes running on a given one of the VMs. For example, each of the VMs can implement anomalous order quantity detection control logic and item quantity prediction functionality for one or more processes running on that particular VM.

An example of a hypervisor platform that may be used to implement a hypervisor within the virtualization infrastructure 404 is the VMware® vSphere® which may have an associated virtual infrastructure management system such as the VMware® vCenter™. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system. Such implementations can provide anomalous order quantity detection functionality of the type described above for one or more processes running on different ones of the containers. For example, a container host device supporting multiple containers of one or more container sets can implement one or more instances of anomalous order quantity detection control logic and item quantity prediction functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises at least a portion of the given system and includes a plurality of processing devices, denoted 502-1, 502-2, 502-3, . . . 502-K, which communicate with one another over a network 504. The network 504 may comprise any type of network, such as a WAN, a LAN, a satellite network, a telephone or cable network, a cellular network, a wireless network such as WiFi or WiMAX, or various portions or combinations of these and other types of networks.

The processing device 502-1 in the processing platform 500 comprises a processor 510 coupled to a memory 512. The processor 510 may comprise a microprocessor, a microcontroller, an ASIC, an FPGA or other type of processing circuitry, as well as portions or combinations of such circuitry elements, and the memory 512, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 4 or 5, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxBlock™, or Vblock® converged infrastructure commercially available from Dell Technologies.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining a plurality of data records, wherein each data record corresponds to a different item grouping of one or more items and comprises a plurality of feature values related to the corresponding item grouping, wherein the plurality of feature values comprises a first feature group comprising one or more first feature values related to an entity associated with the corresponding item grouping and a second feature group comprising one or more second feature values related to one or more quantities associated with the corresponding item grouping, and wherein the entity associated with the corresponding item grouping is one of a plurality of entities associated with the plurality of data records;
in response to obtaining a new data record corresponding to a given item grouping of one or more items and being associated with a given entity:
generating a prediction of an expected quantity of at least one of the one or more items of the given item grouping associated with the new data record, wherein the expected quantity of the at least one item of the given item grouping is obtained by:
evaluating a pairwise similarity score between the given entity and each of at least one entity of the plurality of entities based at least in part on a pairwise entity similarity value, between the given entity and the at least one entity, using the one or more first feature values and a pairwise quantity similarity value, between the given entity and the at least one entity, using the one or more second feature values;
identifying one or more entities of the plurality of entities having a pairwise similarity score with the given entity that satisfies one or more entity similarity criteria; and
determining the expected quantity of the at least one item of the given item grouping using an aggregation of: (i) the pairwise similarity score between the given entity and each of the identified one or more entities of the plurality of entities and (ii) the corresponding quantity of the at least one item of the given item grouping associated with each of the identified one or more entities of the plurality of entities;
comparing the expected quantity of the at least one item of the given item grouping to a quantity of the at least one item indicated in the new data record; and
performing one or more automated remedial actions in response to a result of the comparing,
wherein the method is performed by at least one processing device comprising a processor coupled to a memory.

2. The method of claim 1, wherein the one or more second feature values related to one or more quantities associated with the corresponding item grouping comprise a plurality of binary features each having a first binary value if a respective quantity exceeds a specified threshold and a second binary value if the respective quantity does not exceed the specified threshold.

3. The method of claim 1, further comprising assigning a first weight to the pairwise entity similarity value and a second weight to the pairwise quantity similarity value.

4. The method of claim 1, wherein each different item grouping corresponds to an order quote for the one or more items.

5. The method of claim 1, wherein the one or more first feature values related to the entity associated with the corresponding item grouping comprise a value for one or more of a buying power of the entity associated with the corresponding item grouping, a number of employees of the entity associated with the corresponding item grouping, and a revenue of the entity associated with the corresponding item grouping for one or more item classes.

6. The method of claim 1, wherein the one or more second feature values related to the one or more quantities associated with the corresponding item grouping comprise a quantity value for each of a plurality of item classes in the corresponding item grouping.

7. The method of claim 1, wherein the comparing comprises evaluating a difference between the expected quantity of the at least one item of the given item grouping and the quantity of the at least one item indicated in the new data record.

8. The method of claim 7, further comprising aggregating the difference for each of the one or more items in the given item grouping.

9. The method of claim 1, further comprising adjusting the expected quantity of the at least one item using a factor based at least in part on one or more of: (i) a number of different items common to the given entity and each of the identified entities, and (ii) a ratio, for each item in the given item grouping and for each of the identified entities, of a first quantity of the respective item associated with the given entity and a second quantity of the respective item associated with each identified entity.

10. An apparatus comprising:
at least one processing device comprising a processor coupled to a memory;
the at least one processing device being configured to implement the following steps:
obtaining a plurality of data records, wherein each data record corresponds to a different item grouping of one or more items and comprises a plurality of feature values related to a corresponding item grouping, wherein the plurality of feature values comprises a first feature group comprising one or more first feature values related to an entity associated with the corresponding item grouping and a second feature group comprising one or more second feature values related to one or more quantities associated with the corresponding item grouping, and wherein the entity associated with the corresponding item grouping is one of a plurality of entities associated with the plurality of data records;
in response to obtaining a new data record corresponding to a given item grouping of one or more items and being associated with a given entity:
generating a prediction of an expected quantity of at least one of the one or more items of the given item grouping associated with the new data record, wherein the expected quantity of the at least one item of the given item grouping is obtained by:
evaluating a pairwise similarity score between the given entity and each of at least one entity of the plurality of entities based at least in part on a pairwise entity similarity value, between the given entity and the at least one entity, using the one or more first feature values and a pairwise quantity similarity value, between the given entity and the at least one entity, using the one or more second feature values;
identifying one or more entities of the plurality of entities having a pairwise similarity score with the given entity that satisfies one or more entity similarity criteria; and
determining the expected quantity of the at least one item of the given item grouping using an aggregation of: (i) the pairwise similarity score between the given entity and each of the identified one or more entities of the plurality of entities and (ii) the corresponding quantity of the at least one item of the given item grouping associated with each of the identified one or more entities of the plurality of entities;
comparing the expected quantity of the at least one item of the given item grouping to a quantity of the at least one item indicated in the new data record; and
performing one or more automated remedial actions in response to a result of the comparing.

11. The apparatus of claim 10, wherein the one or more second feature values related to one or more quantities associated with the corresponding item grouping comprise a plurality of binary features each having a first binary value if a respective quantity exceeds a specified threshold and a second binary value if the respective quantity does not exceed the specified threshold.

12. The apparatus of claim 10, further comprising assigning a first weight to the pairwise entity similarity value and a second weight to the pairwise quantity similarity value.

13. The apparatus of claim 10, wherein the one or more first feature values related to the entity associated with the corresponding item grouping comprise a value for one or more of a buying power of the entity associated with the corresponding item grouping, a number of employees of the entity associated with the corresponding item grouping, and a revenue of the entity associated with the corresponding item grouping for one or more item classes.

14. The apparatus of claim 10, wherein the one or more second feature values related to the one or more quantities associated with the corresponding item grouping comprise a quantity value for each of a plurality of item classes in the corresponding item grouping.

15. The apparatus of claim 10, wherein the comparing comprises evaluating a difference between the expected quantity of the at least one item of the given item grouping and the quantity of the at least one item indicated in the new data record and aggregating the difference for each of the one or more items in the given item grouping.

16. A non-transitory processor-readable storage medium having stored therein program code of one or more software programs, wherein the program code when executed by at least one processing device causes the at least one processing device to perform the following steps:
obtaining a plurality of data records, wherein each data record corresponds to a different item grouping of one or more items and comprises a plurality of feature values related to a corresponding item grouping, wherein the plurality of feature values comprises a first feature group comprising one or more first feature values related to an entity associated with the corresponding item grouping and a second feature group comprising one or more second feature values related to one or more quantities associated with the corresponding item grouping, and wherein the entity associated with the corresponding item grouping is one of a plurality of entities associated with the plurality of data records;
in response to obtaining a new data record corresponding to a given item grouping of one or more items and being associated with a given entity:
generating a prediction of an expected quantity of at least one of the one or more items of the given item grouping associated with the new data record, wherein the predicted expected quantity of the at least one item of the given item grouping is obtained by:
evaluating a pairwise similarity score between the given entity and each of at least one entity of the plurality of entities based at least in part on a pairwise entity similarity value, between the given entity and the at least one entity, using the one or more first feature values and a pairwise quantity similarity value, between the given entity and the at least one entity, using the one or more second feature values;
identifying one or more entities of the plurality of entities having a pairwise similarity score with the given entity that satisfies one or more entity similarity criteria; and
determining the expected quantity of the at least one item of the given item grouping using an aggregation of: (i) the pairwise similarity score between the given entity and each of the identified one or more entities of the plurality of entities and (ii) the corresponding quantity of the at least one item of the given item grouping associated with each of the identified one or more entities of the plurality of entities;
comparing the expected quantity of the at least one item of the given item grouping to a quantity of the at least one item indicated in the new data record; and
performing one or more automated remedial actions in response to a result of the comparing.

17. The non-transitory processor-readable storage medium of claim 16, wherein the one or more second feature values related to one or more quantities associated with the corresponding item grouping comprise a plurality of binary features each having a first binary value if a respective quantity exceeds a specified threshold and a second binary value if the respective quantity does not exceed the specified threshold.

18. The non-transitory processor-readable storage medium of claim 16, wherein the one or more first feature values related to the entity associated with the corresponding item grouping comprise a value for one or more of a buying power of the entity associated with the corresponding item grouping, a number of employees of the entity associated with the corresponding item grouping, and a revenue of the entity associated with the corresponding item grouping for one or more item classes.

19. The non-transitory processor-readable storage medium of claim 16, wherein the one or more second feature values related to the one or more quantities associated with the corresponding item grouping comprise a quantity value for each of a plurality of item classes in the corresponding item grouping.

20. The non-transitory processor-readable storage medium of claim 16, wherein the comparing comprises evaluating a difference between the expected quantity of the at least one item of the given item grouping and the quantity of the at least one item indicated in the new data record and aggregating the difference for each of the one or more items in the given item grouping.
